(19) United States
(12) Patent Application Publication
(10) Pub. No.: US 2014/0214684 A1
(43) Pub. Date: Jul. 31, 2014

(54) SYSTEM AND METHOD FOR ELECTRONIC COMMERCE AND FABRICATION OF 3D PARTS

(71) Applicant: Barney D. Pell, San Francisco, CA (US)

(72) Inventor: Barney D. Pell, San Francisco, CA (US)

(21) Appl. No.: 14/342,978

(22) PCT Filed: Sep. 10, 2012
(86) PCT No.: PCT/US12/54484

§ 371 Date: Mar. 5, 2014

Related U.S. Application Data
(60) Provisional application No. 61/533,070, filed on Sep. 9, 2011.
(60) Provisional application No. 61/540,919, filed on Sep. 29, 2011.

(51) Int. Cl. G06F 21/60

(52) U.S. Cl. CPC G06F 21/602
USPC 705/57

(57) ABSTRACT

A 3D parts creation and management system includes a digital rights management system for managing at least one digital right associated with at least one model. At least one model of a 3D part is provided. The system includes at least one of a digital rights management system and a copy protection system. The digital rights management system manages at least one digital right associated with the at least one model, and the copy protection system encrypts the at least one model with at least one encryption. An electronic commerce system is in communication with at least one of the digital rights management system and the copy protection system, wherein the electronic commerce system controls at least one of purchasing, manufacturing, and delivering of a 3D part created from the at least one model.

The present disclosure is generally related to printing technology, and more particularly is related to a system and method for electronic commerce for fabrication of 3D parts. The invention has particular utility in connection with fabrication of 3D parts from digital data using, e.g., 3D fabrication devices such as 3D printers, and will be described in connection with such utility, although other utilities are contemplated.

The product lifecycle of most major products is driven by the quality and availability of spare and replacement parts. Processes are based on a world in which parts are manufactured in large batches by manufacturers or third parties and then stored in inventories at the manufacturer, dealer, or repair facility. When manufacturers stop producing the products and manufacturing of parts, eventually it becomes difficult or impossible to find the replacement parts, after which the unsupported products become unmaintainable and hence unusable by end users.

As an example, a utensil compartment in a dishwasher no longer stays shut, because the small part that serves as a fastener ceased retaining its shape. The repairman attempts to order a replacement part, which would cost $5 a few years earlier, but the dishwasher is no longer in production and the manufacturer no longer stocks replacement parts for it. Although the dishwasher is only 7 years old and is otherwise in perfect condition, the end user must operate it at a diminished level or buy a replacement because the basic part has been discontinued.

Similar problems are common among a variety of products. These products include appliances, bicycles, autos, boats, planes, electronics (including design of circuit boards from digital models), furniture, homes, recreational equipment and sporting goods, healthcare/medical, aerospace, robots, and industrial machinery. The parts include specialized components (like a metal+plastic fastener as in the example above), but also simple components such as nuts, bolts, clips, and screws, which can be shaped to industry. standards, or custom for a certain vendor or product category. Within the same problem space also lie tools, which can be generic, like different sizes of screwdrivers, or specialized, like a pin that resets a smart phone, a key that opens a battery compartment, or a ratchet that is used for a specific piece of furniture from Ikea.

Thus, a heretofore unaddressed need exists in the industry to address the aforementioned deficiencies and inadequacies.

Embodiments of the present disclosure provide a system and method for a 3D parts creation and management system. Briefly described, in architecture, one embodiment of the system, among others, can be implemented as follows. At least one model of a 3D part is provided stored on non-transitory machine-readable media. The system includes at least one of a digital rights management system and a copy protection system. The digital rights management system manages at least one digital right associated with the at least one model, and the copy protection system encrypts the at least one model with at least one encryption. An electronic commerce system is in communication with at least one of the digital rights management system and the copy protection system, wherein the electronic commerce system controls at least one of purchasing, manufacturing, and delivering of a 3D part created from the at least one model.

The present disclosure can also be viewed as providing method of 3D parts creation and management. In this regard, one embodiment of such a method, among others, can be broadly summarized by the following steps: managing at least one digital right of at least one model with a digital rights management system; encrypting the at least one model with at least one encryption; and controlling at least one of purchasing, manufacturing, and delivering of a 3D part created from the at least one model.

In another aspect, the present disclosure provides a 3D parts system. The 3D parts system includes a 3D parts database having at least one model of a 3D part stored on non-transitory machine-readable media, wherein the 3D parts database is electronically accessible to a 3D parts fabrication device and a user computer device, such that a user of the user computer device may select a model of a 3D part from the database to be fabricated by the 3D parts fabrication device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Many aspects of the disclosure can be better understood with reference to the following drawings. The components in the drawings are not necessarily to scale. Instead emphasis is being placed upon illustrating clearly the principles of the present disclosure. Moreover, in the drawings, like reference numerals designate corresponding parts throughout the several views.

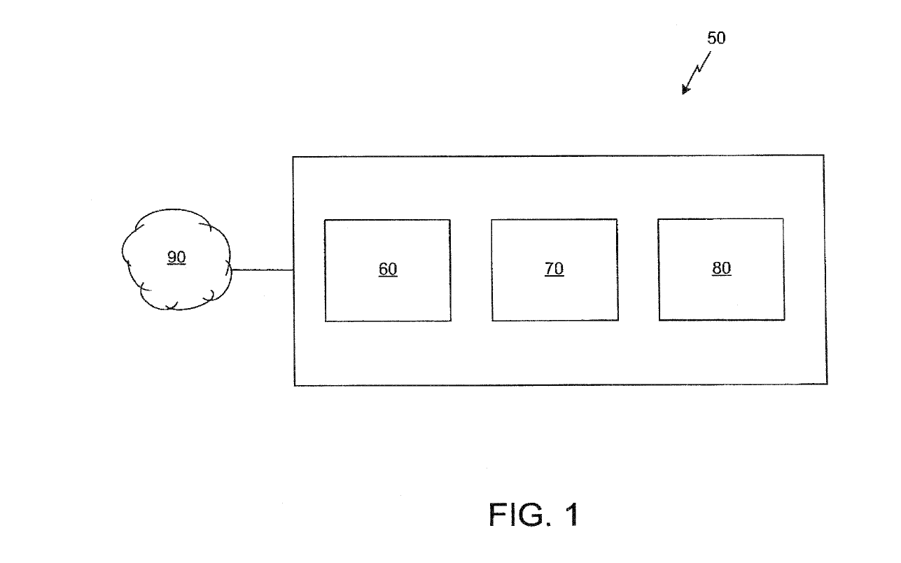

FIG. 1 is a block diagram of a 3D parts creation and management system, in accordance with a first exemplary embodiment of the present disclosure

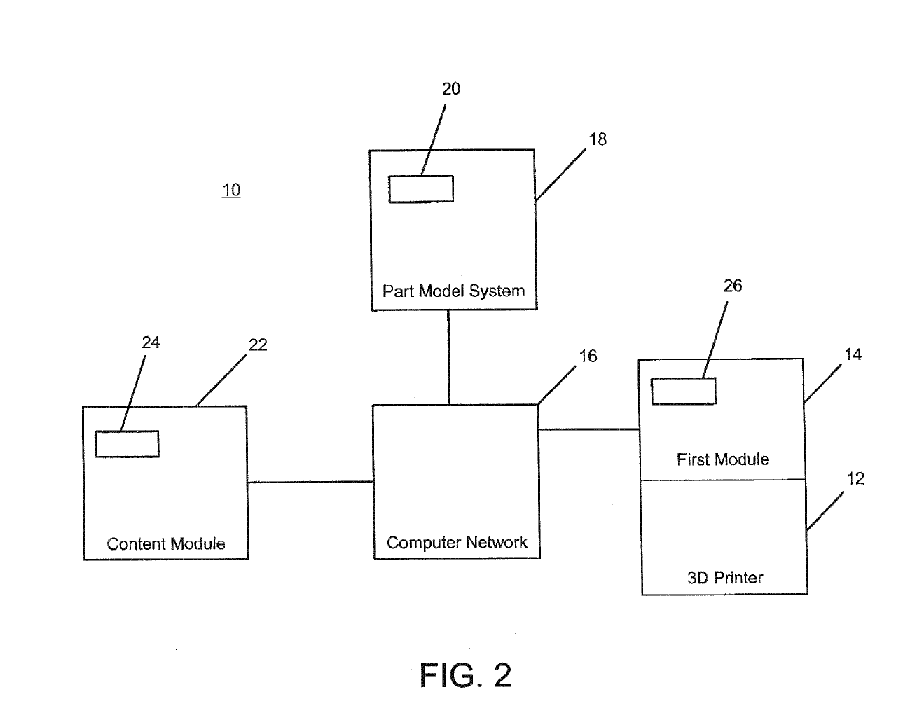

FIG. 2 is a block diagram of a 3D print system, in accordance with a second exemplary embodiment of the present disclosure.

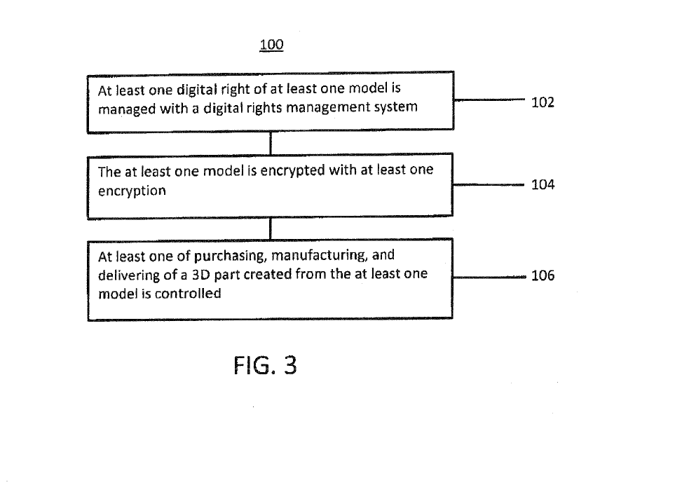

FIG. 3 is an illustration of a flowchart illustrating a method for 3D parts creation and management utilizing the system of FIG. 1, in accordance with the first exemplary embodiment of the present disclosure.

New fabrication technologies, under the general rubric of 3D printing (including, but not limited to, additive manufacturing, subtractive manufacturing, automated welding, other workshop automation, rapid prototyping systems, injection modeling, and even 2D printing) have the potential to reduce or remove the need for pre-built inventory of the wide variety of parts described above. Instead of storing each part physically, a model of the part is stored on non-transitory machine-readable media.

A service can be created in which, instead of finding and buying a physical product, a user finds and procures a model for the product. Procuring could include buying, obtaining for free, or using an organizational accounting system in lieu of actual payment. Once a user procures a model, they can use the model to fabricate the product. Compared to e-commerce based systems of buying physical products, the extension to buying models of physical products has new benefits, as well as new complexities. The benefits and complexities generate requirements for innovative solutions that are addressed in the disclosures discussed herein.

FIG. 1 is a block diagram of a 3D parts creation and management system 50, in accordance with a first exemplary embodiment of the present disclosure. The 3D parts creation and management system 50, hereinafter referred to as ‘system 50’ may include any components, systems and sub-systems to effectively manage and create 3D parts. The system 50, in a simplistic view, may include any one, or any combination of three sub-systems: a digital rights management (DRM) system 60, a copy protection system 70, and an electronic commerce system 80, all of which may be in communication with each other internally, and externally via a network connection 90. As is shown in FIG. 1, the system 50 may generally be understood to have the DRM system 60, the copy protection system 70 and the electronic commerce system 80. Of course, additionally sub-systems may be included as is discussed in additional embodiments herein and in related disclosures. For example, the system 50 may include any number of communication system, fabrication systems, marketing systems, or other systems that may be desired to be used with the system 50.

The DRM system 60, the copy protection system 70, and the electronic commerce system 80 all work in conjunction with 3D parts, which can be used for any purpose and constructed from any type of material. When a consumer desires to obtain a 3D part, such as to replace a broken or malfunctioning 3D part, the consumer may engage the system 50, either directly or through any number of intermediaries. The system 50 may contain or have access to a plurality of 3D models stored on non-transitory machine-readable media, which can be used to reconstruct the physical 3D part that the consumer wishes to have. Any of the models may be subjected to various intellectual property protections, including copyright protection, or other legal rights which one may be entitled to have with the model. As such, the DRM system 60 may store characteristics of the model relating to the type of rights associated with the model, any other aspects of the proper usage of the model, including permissions to use that have been granted, licenses, quantity or manufacture restrictions, as well as others. The DRM system 60 may manage any of the rights associated with the models to ensure that use of the models is legal and proper.

The copy protection system 70 may be separate or integral with the DRM system 60 discussed above. The copy protection system 70 may be used to ensure that illegal or improper copying of the models, or 3D parts, is prevented. For example, the copy protection system 70 may record any manufacturing of 3D parts in a database, which may be in communication with the DRM system 60. The copy protection system 70 may coordinate or determine the actual usage or manufacturing of the 3D part in relation to permissions and rights stored within the DRM system 60 to determine if an error exists between the number or type of 3D part created and the various allowances. This may be used to prevent unauthorized copying of 3D parts, or illegal communication of data relating to the models or the 3D parts. The copy protection system 70 may also include methods of encryption to technologically impede unauthorized copying, or to identify counterfeit products as such. For example, an electronic signature or key may be given to electronic models to encrypt the models. A corresponding signature or key may be provided to the authorized user of the model only, such that anyone attempting to use the model without the corresponding signature of key is unable to do so. Any of the encryption techniques used by the copy protection system 70 may allow for various restrictive uses of the model, including quantity restrictions, territorial restrictions, and/or time restrictions.

The copy protection system 70 or the DRM system 60 (or an action in combination with each other and/or with a 3D fabrication device) could also modify the model of a 3D part so that the fabricated part will be identifiable. This can be thought of as digital watermarking to create physical watermarks. As an example, the system could modify the model to include specifications that add the name of the customer, the identity of the fabrication machine, the time of fabrication, the fabrication number of this particular part in a series of authorized copies, or other rights-related information. This capability, along with other DRM and copy protection capabilities, could be embedded in a 3D fabrication device. Additionally, it is noted that the copy protection system 70 and the DRM system 60 may be used together or independently with the system 50. For example, the system 50 may be used to log the number of times a 3D part is created, and/or restrict such printing with the DRM system 60, even when the 3D part is not encrypted with the copy protection system 70. Likewise, it may be desirable to encrypt a 3D part with the copy protection system 70 that can be used on a fabrication device (3D) 7 printer) with or without the DRM system 60.

The electronic commerce system 80 may be used to manage the sales and manufacture of the 3D parts. For example, the electronic commerce system 80 may receive buyer requests for parts, communicate with the buyers and manufacturers to initiate production of the 3D parts, communicate with the DRM system 60 and copy protection system 70 to ensure proper usage of the 3D parts, oversee billing and payments for the 3D parts, and oversee proper delivery of the finish 3D parts to the consumer. Naturally, the electronic commerce system 80 may include or be in communication with the devices for manufacturing the 3D parts, such as a 3D printer or any other fabrication device that can be used to produce 3D parts. Although 3D printers may be used commonly, as is described in the second exemplary embodiment herein, other devices for the production of 3D parts may also be used with the system 50. The electronic commerce system 80 may communicate with channels of sales and delivery of the 3D parts, and therefore be capable of receiving electronic orders for 3D parts and any payments associated with them.

FIG. 2 is a block diagram of a 3D print system 10, in accordance with a second exemplary embodiment of the present disclosure. In relation to the first exemplary embodiment of FIG. 1, the second exemplary embodiment includes the disclosure of many components, systems, and sub-systems that may be used to enable the 3D print system 10 to be efficiently used in a variety of settings. Any of the disclosures with respect to the first exemplary embodiment may be included with the second exemplary embodiment, and vice-versa, as well as variations, functions and features not explicitly discussed herein, all of which are considered within the scope of this disclosure.

As is shown in FIG. 2, the 3D print system 10 includes a 3D printer 12. The 3D printer 12 is capable of taking a part model and fabricating a product. A first module 14 communicates with the 3D printer 12 and is connected to a computer network 16. The first module 14 includes a unique identifier that is correlated to the first module 14, a part model database containing at least one part model identifier, at least one unique transaction identifier correlating the unique identifier and the part model identifier from a transaction, and at least one transaction term from the transaction. A part model system 18 is in communication with the first module 14 over the computer network 16. The part model system 18 includes a part model database containing the part model identifier, the unique transaction identifier, and the transaction term from the transaction.

A PMS processor 20 communicates with the part model system 18. The PMS processor 20 validates the unique transaction identifier stored within both the first module 14 and the part model system 18, creates a key to access the part model under restrictions of the transaction term, directs transmission of the key from the part model system 18 to the first module 14, and records the transmission in the part model database. A content module 22 communicates with the first module 14 through the computer network 16 and contains the part model.

A CM processor 24 communicates with the content module 22, receives the key and the transaction term from the first module 14 and transmits the part model to the first module 14 under restrictions of the transaction term. An FM processor 26 communicates with the first module 14, monitors each production of the product by the 3D printer 12 based on the part model, restricts production of the product in accordance with the transaction term, and causes monitoring information to be transmitted from the first module 14 to the part model system 18. The completion of the transaction performance is recorded in the part model database.

A part model can be a digital model, photos, diagrams, parts construction manuals, and any other way of precisely specifying how to build, finish, and/or test a specific part. The term ‘part’ in part model is not intended to suggest the product is a sub-element of a greater product or one of a plurality of elements that make a whole, but is understood to be any object that can be produced by the 3D printer 12. Part models are assembled and organized in the part model database. The part model database can be single instance or any form of distributed database, including non-traditional database systems. The models can be provided by a number of different types of model providers including designers, manufacturers, repair professionals, consumers, and others. Manufacturers can provide models for any of the parts used with or in any of the products they manufacture.

Many manufactures already have part models for all their products. Their digital models are stored in one of a variety of standard or proprietary formats. A variety of model adaptors can be built to adapt semi-automatically a model in an existing format into a parts model that can be used for our semi-automated fabrication system discussed herein. In some cases, the adaptation process is simply a matter of format translation. In other cases, the adaptation process can require additional annotation and transformation in order to support higher levels of automation. For example, most existing digital models do not specify test procedures for parts. They also might omit assembly instructions for complex parts. Adding any of these could be done manually, or via intelligent systems, or a combination thereof.

For some parts, manufacturers may not have part models, or the models may not be in appropriate form for the automation system described herein. Manufacturers could create appropriate models using tools designed to support such efforts, including CAD modeling tools, 3D part scanning tools, tools that record parts as they are being assembled, finished, and tested, and tools that integrate or combine the output of other tools into a finished model. Even with such tools, manufacturers may not want to do the additional work, or they may not want to make whatever models they have available to certain classes of users, or they may want to charge very high prices. This proprietary protection could result in a lack of affordable and high quality parts or part models available in the database.

Third parties, such as repairmen, tinkers, hobbyists, and makers, are another type of product model provider. They can use similar tools as discussed above and similar methods for providing their product models to a product model database service. Besides creating models for products for which models are not available from manufacturers, these third parties can create identical products but with different pricing terms from the original manufacturer. They can also create different versions of a particular product. Versions of a product may share a same primary product identifier, and can generally be used in place of the original product version, but the models are different. Differences in the part models between versions can result in identical final products but with differences in the process, leading to different fabrication costs, times, dependencies, error rates, etc. Or the differences can result in qualitatively different (but still interoperable) products. For example, a different choice of materials could lead to stronger, cheaper, lighter, or higher quality final parts.

When any type of product model provider provides their product models, they can also specify transaction terms, such as pricing and payment, along with potential restrictions on the use of the part models they provide. Any of these terms can be updated subsequently and dynamically by manual or automated instructions provided to the part model system 18. Pricing terms can specify a price per single use of the part model, a price per multiple uses (e.g. a price for producing a batch of size within a range, with different pricing for different ranges), and time-varying offers and coupons. For example, there may be a 20% discount if the part model is purchased or used for fabrication within the next week, and a 30% discount from the single-unit price if the part model is used to produce between 100-200 units.

Restrictions can specify, for example, only certain types of users can or cannot use the system, where user types may include end users, dealers, repair houses, affiliations with a manufacturer or competitors. Restrictions could also specify whether the end user is an original purchaser of the product associated with the part, whether the product or part is under warranty, and whether the user paid for a maintenance plan. Restrictions may also contain temporal or spatial constraints, e.g. permitting parts to be fabricated only within a certain time or place.

Purchasing, pricing and payment terms and restrictions can be effected and enforced in a variety of ways. Purchasing can be performed similar to any other transaction for digital or physical goods. Examples of digital purchases include online retail purchase of physical goods (e.g., books) and/or digital good (e.g., a digital music file). A purchaser may execute (including digitally) a purchase agreement agreeing to the terms and restrictions specified and explicitly protecting intellectual property of the product model provider. Their credit card or other preferred payment system may be used to complete the transaction. While the product model provider's intellectual property rights may be protected by contract, there is a risk that the intellectual property is used accidentally or intentionally in ways that violate the contract. For example, a purchaser could distribute copies of the product model so that others can use it for free. Or a purchaser could fabricate multiple products while paying for only one.

In order to provide further protection and enforcement of contractual limitations, one embodiment of the system supports digital rights management (DRM), potentially including copy protection and controlled execution. Copy protection can include a variety of methods of encryption, among other means, to technologically impeded unauthorized copying. A product model provider may deliver a product model and a terms specification to the part model database in the part model system 18. The terms are expressed in a term specification language (TSL). The part model system 18 applies copy protection to the product model to create a protected product model (PPM). The part model system 18 also applies copy protection to the terms specification to create a protected terms specification (PTS). The part model system 18 stores the PPM and the PTS in the part model database, associated with identifiers for the product (the product identifier, PID) and the product model provider (the product model provider identifier, or PMPTD).

When a user later finds a result for a product in the part model system 18, as discussed below, the user can purchase the product model. The part model system 18 creates a transaction record containing the user identifier (UTD), PID, the newly generated unique transaction identifier (TID), the terms specification, and the PMPID. The part model system 18 then creates a new PPM and PTS from the original stored PPM and PTS by unprotecting the originals and instantiating new copy protected versions specifically for this transaction. The part model system 18 provides the new PPM and PTS and associated data to the user (e.g. by digital download). The user then forwards the protected versions of the purchased content and control data (PPM, PTS, and TID, among other items) to a fabrication service.

If the content is fully encrypted, then a user doesn't know which fabrication services can be used as the first next step. The part model system 18 may provide a summary plan for all the types of fabrication service providers that will be needed in total fabrication, and the user can search for fabrication providers of each type, and send the content to any fabricator which is consistent with the returned fabricator types. The fabrication service may be a machine or similar electronic agent, for example a 3D printer 12. In the case of an ordinary 3D printer 12 (which takes a digital model and fabricates a single product), it may be equipped with the first module 14 and the content module 22.

The first module 14 contacts the part model system 18 by some electronic communication means, possibly over the computer network 16, and provides the PPM, PTS, TID, and also a unique fab service identifier (FSID). The part model system 18 checks the authorization of the FSID for this transaction, and if authorized then the part model system 18 creates a new key based on the data provided, stores the key and provided data in a record for this processing step, and provides the key to the first module 14. The key is a piece of data designed to unlock some of the copy protection around the PPM and PTS. An example could be a public key. The first module 14 provides the key to the content module 22 and gets back some or all of the content unlocked, along with some content that remains locked. Hence it has an unlocked terms specification and a protected terms specification, an unlocked part model and a protected part model.

The first module 14 may check the unlocked terms specification to determine whether the execution is consistent with the terms. The first module 14 counts the number of times the product has been successfully executed on the 3D printer 12. With each iteration, the first module 14 checks whether the number of copies is consistent with the terms. If the terms permit another copy, then this passes to the next step. If the terms do not permit another copy, then the first module 14 returns an error and does not proceed to further execution steps. The first module 14 checks the temporal and spatial information associated with the terms and compares this with the current time and current location or zone (if available). If the comparison check is not valid, then the first module 14 reports the error to the user and does not proceed with execution.

For example, a user may have purchased a product model that can be printed 3 times in North America in the month of May. If the fabrication service is invoked to print a product in Asia or in June, or to print the fourth part, then the operation will be rejected as unauthorized. The first module 14 passes the unlocked content to the 3D printer 12 to execute the next step of the content. If the 3D printer 12 reports that the step failed, then the first module 14 can attempt to repeat the step until either the step succeeds or a failure counter is exceeded. If the count is exceeded, then the execution process fails and the first module 14 notifies the part model system 18 of the failure. If the step succeeds, then if there are no more steps, then the first module 14 reports to the part model system 18 that this fabrication instance is complete. The part model system 18 updates the activity log for this transaction. If there are more steps remaining, then the first module 14 repeats the authorization, unlocking, and execution cycle. On subsequent cycles, there may be new authorizations. new keys. and newly unlocked content.

The content module 22 receives a key and some locked content, and unlocks a portion of the content that can be executed on this machine, using a key provided to it. Both the key and the locked content may be provided to the content module 22 by the first module 14. In the case of a simple product, in a simple embodiment, the entire content can be unlocked and executed on the 3D printer 12.

A more complex embodiment of a simple product could have progressive content unlocking as the fabrication is executed on the machine. In one example, each layer of a 3D printing process can be unlocked just in time. The benefit of this approach is that there may never be a single unlocked copy of the entire product, hence improving the copy protection and digital rights management. In the case of a complex product, it is only necessary to unlock a portion of the content on the 3D printer 12. The other content will be unlocked on machines that can execute the different sub products.

A user may search for a desired part in a part model system (PMS) 18, which contains the second part model database 20. The search process can use a variety of means of information retrieval. Information retrieval methods induce keyword search, faceted navigation, search by product, search by part type, search by part number, selection of items within a diagram, contextual linkage from other documents including web pages, among many other approaches. The search process provides results containing the desired part description, its associated part identifier and part model.

The user selects, and optionally purchases, the model and forwards it to a fabrication service that uses the model to fabricate the desired part. The fabrication service could be any combination of zero or more people and machines. For example, a simple part might be printed from the model on the 3D printer 12 using material already stored in the 3D printer 12. A more complex part might have a model that contains instructions to prepare the 3D printer 12 with a specific material, which is then used to print the part. A still more complex part might have a model that specifies models for two or more sub-parts, and then has instructions for how to assemble the sub-parts into the final part. Assembly instructions could be, for example, printed and manually executed or digital and machine executed. Some components may be pre-stocked in inventory by a fabrication service, in which case a model that refers to the sub-parts by their part identifiers enables a fabrication service to choose whether to fabricate or retrieve the component part from inventory.

A part may be assembled by a combination of distinct fabrication services that can be geographically separated. Each fabrication service assembles their (sub-)part, and then finishes and tests the part for quality, performing each of these type of actions according to specifications and instructions in the model for that part. The fabrication service then sends the part to another fabrication service or ultimately to the end recipient, which could be for example a warehouse, dealer, repair service, or the end product owner.

FIG. 3 is an illustration of a flowchart 100 illustrating a method for 3D parts creation and management utilizing the system 50 of FIG. 1, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, at least one digital right of at least one model is managed with a digital rights management system. The at least one model is encrypted with at least one encryption (block 104). At least one of purchasing, manufacturing, and delivering of a 3D part created from the at least one model is controlled (block 106).

On-demand fabrication may diminish a need for pre-stocking product inventory. This diminished need results in less wastage, less inventory storage costs, less inventory management overhead, reduced shipping costs, faster delivery time, lower delivered costs per product, lower prices and delivery waiting times for buyers, and reduced out-of-stock scenarios, which disappoint users and lose money for manufacturers and retailers. Manufacturers, merchants, and distributors will benefit from tools and services to optimize inventory levels given previous, current, and projected availability and demand. For example, it might make sense to pre-fabricate and maintain high levels of inventory for best-selling products, which can be made using economies of scale, or very complex products, which would be expensive or impossible for buyers to fabricate, while leaving simpler or lower volume of purchase products to be available for purchase solely as models.

On-demand fabrication gives the possibility for delivery that is instant and anywhere. Instant delivery is always convenient, but has high value in many time-sensitive scenarios such as medical or defense, or in any situation in which products are needed to maintain or repair other systems that would otherwise be unutilized while waiting for the physical product to be shipped. Delivery anywhere has value for remote applications for which shipping would be costly or impossible. This includes customers at sea, in the air, in space, in war zones, in rural or third-world locations with limited transportation networks, or anywhere that is far. from a specific product manufacturer. On-demand fabrication gives the possibility for personalization and mass customization, in which each buyer or user can fabricate a product that is unique for them, instead of buying the same product that will be of use to a larger customer base.

At an extreme of on-demand personalization, a system (which could be manual, semi-automated or fully automated) could take as input a user's preferences, requirements, constraints, and context for a product and generate as output a model specifically designed to produce a product that is optimized for these inputs. For example, a user who wants low cost could get a model generated that prints on a cheap printer. Or a user who has a specific 3D printer at home could get a model that prints well exactly on that printer. While a user who is happy to wait a long time for production and wants the highest quality could get a high precision model that requires expensive fabrication machines, using the finest raw materials, operated by a high-end service regardless of distance from the buyer.

Diminished need for inventory means increased shelf space for product options. For manufacturers, distributors, and retailers, there is no need to stop carrying a product, or to anticipate which product styles and options will be most in-demand and which ones to cut. For users, they get increased selection, lower prices, and longer product lifetime due to ongoing availability of spare parts, tools, and accessories even for discontinued products. Diminished need for inventory also lowers the barriers to entry for smaller players to get their products to market. Rather than requiring their own factories to fabricate a sufficient number of products to be interesting to a distribution partner, a small player can deliver the model for their product in digital form and let the buyer or distributor bear the costs of the actual fabrication.

Some products may require multiple machines to touch a single work-in-process For example, one machine may create the structure, another may polish, a third may paint, and a forth may etch fine details. Some products may need to be produced in parts and then assembled. The models for products could be represented in a form that handles these complexities. This requires model representation languages and model development tools. For example, the model could specify an order of machines to pass a work-in-progress along with instructions to be executed on each machine and instructions for individuals (if appropriate) about setup, cool-down, waiting, and transfer of the work-in-progress through the overall process. For a product made of several parts, the model could specify sub-models for each part, along with assembly instructions for manual or automated execution.

Fabrication systems need to interpret the representational elements of such models and execute them correctly and efficiently (or even optimally). An example is a machine that assembles sub-parts into a larger part. This machine will need to interpret and execute assembly instructions in a model. If the assembly is manual, then the individual will still benefit from execution and decision support tools that operate on information expressed in the models for these purposes. In a complex case, a purchaser of a model could perform the fabrication indirectly by sharing the model with one or more third-parties who can then do the fabrication using the model directly or indirectly again. Ultimately third parties may deliver the product to the user either in assembled form (from a single assembling party, in the case of multi-part products) or in parts ready for assembly by the user.

In order for execution of complex fabrication models to be further automated, we need efficient methods to process, store, and route intermediate and final work products. The goal is to create a modular assembly line that can be deployed within a workshop. It should be modular in the sense that any type of fabrication machine can plug in and interface with the assembly line systems and data transfer, according to standardized specifications designed for this purpose. The machines will support a standard form of logic for processing assembly line-type instructions from the fabrication models. We develop several means for this. One design is as follows:
A modular conveyor system has several components.
One is a means to move a fabricated component (finished or in-process) between (a) the working site of a fabrication machine(for example, the oven of a furnace) and (b) a loading and unloading site of the machine (note: these sites could be different, or a single site).
Second is a means to convey a component between the staging site and a conveyor system. This conveyor system could be, for example, a conveyor belt. Ideally, the conveyor belt is composed of one or more modules that can be connected together, much like the tracks in a car racing toy. This could also be other means of conveyance, including air transport, water transport, tubes, and propulsion systems (e.g. for use in space). Other means of conveyance could be a robotic mechanism, for example a series of grasping arms that hands off each to the next module, or a mobile robot that moves itself and the conveyed object between locations. Humans could play the role of conveyance means in such a system. The system could use any combination of means, including a homogeneous system or a diverse system.
Third is a means to convey a component between the conveyor belt and another staging site. This could be a staging site of another machine, the staging site of the first machine, or a different staging site of the first machine.
   One preferred embodiment is a Race-track style conveyor belt system.
   A customer buys a staging site module that is compatible with his first machine, and another module that is compatible with his second machine.
   For both machines, the customer buys compatible robot arms, and attaches these to his machines.
   The customer then buys a set of conveyor belt modules, and plugs them together in a configuration that runs across his workshop, including next to the staging sites for his two machines.
   The customer then configures the robot arms for each of his machines with the location of the staging area and the location of the conveyor belt nearest to the staging area.
   The modules for each machine are able to send commands to the conveyor belt system to start, stop, change speed, and change direction of the conveyor belt.
Another preferred embodiment is a mobile robot transport system.
   A user buys a single mobile robot.
   The user configures the mobile robot as to the staging areas of the different machines in the workshop.
   The mobile robot receives information and commands from the fabrication model controller and from the individual fabrication machines.
   The robot executes these commands, which include picking up a component from a staging area of a first machine, moving to the location of the second machine, and dropping the component at the staging area of a second machine (which could also be the first machine).

Other modifications are possible. There may be multiple models available for a single base product. Merchants should offer tools to help users choose among different models for their needs. Merchants should offer tools to let users review not just finished products, but also the different models that are available for purchase corresponding to a given product (or product variant). Potential product model contributors would benefit from tools to analyze model reviews, search, and purchase data, to support decisions about new product models to offer. Models that are variants of a base product (in the sense that a user could use different models to fulfill a similar purpose) should have associated an identifier for the variant (so that each model is unique) and also an identifier for the base model or product. Merchants should use this data to organize the variants for users.

It should be emphasized that the above-described embodiments of the present disclosure, particularly, any “preferred” embodiments, are merely possible examples of implementations, merely set forth for a clear understanding of the principles of the disclosed system and method. Many variations and modifications may be made to the above-described embodiments of the disclosure without departing substantially from the spirit and principles of the disclosure. All such modifications and variations are intended to be included herein within the scope of this disclosure and protected by the following claims.

What is claimed is:

1. A 3D parts creation and management system comprising;
at least one model of a 3D part stored on non-transitory machine-readable media;
at least one of:
a digital rights management system for managing at least one digital right associated with the at least one model, and
a copy protection system encrypting the at least one model with at least one encryption; and
an electronic commerce system in communication with at least one of the digital rights management system and the copy protection system, wherein the electronic commerce system controls at least one of purchasing, manufacturing, and delivering of a 3D part created from the at least one model.

2. A 3D parts creation and management system comprising:
at least one model of a 3D part stored on non-transitory machine-readable media;
a fabrication device creating at least one 3D structure from the at least one model; and
a watermarking system in communication with the fabrication device, wherein the watermarking system creates a physical, non-electronic watermark within the 3D part created from the at least one model.

3. The 3D parts creation and management system of claim 2, wherein the physical, non-electronic watermark within the 3D part further comprises at least one of: a name of a customer, an identity of the fabrication device, a time of fabrication, and a fabrication identification number.

4. A system for managing and protecting 3D parts, the system comprising:
at least one model of a 3D part stored on non-transitory machine-readable media;
at least one 3D fabrication device creating at least one 3D structure from the at least one model; and
a 3D parts management and protection system comprising at least one of:
a digital rights management system for managing at least one digital right associated with the at least one model; and
a copy protection system encrypting the at least one model with at least one encryption.

5. A method for 3D parts creation and management comprising the steps of:
managing at least one digital right of at least one model stored on non-transitory machine-readable media with a digital rights management system;
encrypting the at least one model with at least one encryption; and
controlling at least one of purchasing, manufacturing, and delivering of a 3D part created from the at least one model.

6. A production system for use with a 3D parts creation and management system comprising:
at least one model of a 3D part stored on non-transitory machine-readable media;
a 3D fabrication device creating at least one 3D structure from the at least one model, wherein the 3D fabrication device is positioned within a fabrication facility;
a 3D structure transportation system comprising at least one of:
at least one internal transportation device positioned to move the 3D structure between a first fabrication site and a second fabrication site, wherein the first and second fabrication sites are located within the fabrication facility; and
at least one external transportation device positioned to transport the 3D structure between the fabrication facility and a location external to the fabrication facility.

7. The production system for use with a 3D parts creation and management system of claim 6, wherein the production system is communicatively coupled to at least one of:
a digital rights management system for managing at least one digital right associated with the at least one model;
a copy protection system encrypting the at least one model with at least one encryption; and
an electronic commerce system in communication with at least one of the digital rights management system and the copy protection system, wherein the electronic commerce system controls at least one of purchasing, manufacturing, and delivering of a 3D part created from the at least one model.

8. The production system for use with a 3D parts creation and management system of claim 6, wherein the at least one internal transportation device further comprises at least one of: a conveyer system having a plurality of belts, a track system having a plurality of tracks, a conduit system having a plurality of interconnected conduits, a propulsion system, and a robotically-controlled system.

9. The production system for use with a 3D parts creation and management system of claim 7, wherein the at least one internal transportation device further comprises at least one of: a conveyer system having a plurality of belts, a track system having a plurality of tracks, a conduit system having a plurality of interconnected conduits, a propulsion system, and a robotically-controlled system.

10. The production system for use with a 3D parts creation and management of claim 8, wherein the robotically-controlled system further comprises:
a plurality of robotic units movable within the fabrication facility; and
a plurality of interchangeable robotic parts for use with the plurality or robotic units, wherein the plurality of interchangeable robotic parts is selected for use with at least one of the plurality of robotic units based on the 3D structure.

11. The production system for use with a 3D parts creation and management system of claim 6, further comprising a controller in communication with the 3D structure transportation system, wherein the controller determines a location of the 3D structure on the at least one of an internal transportation device and an external transportation device, and executes commands to control the movement of the 3D structure using the at least one of an internal transportation device and an external transportation device.

12. The production system for use with a 3D parts creation and management system of claim 11, wherein the execution of commands to control the movement of the 3D structure by the controller comprises delivering information that can be used by other agents for coordination and execution.

13. The production system for use with a 3D parts creation and management of claim 8, further comprising a controller in communication with the at least one internal transportation device, wherein the controller determines a location of the 3D structure on the at least one internal transportation device, and executes commands to control the movement of the 3D structure using the at least one internal transportation device.

14. A 3D parts system comprising a 3D parts database having at least one model of a 3D part stored on non-transitory machine-readable media, wherein the 3D parts database is electronically accessible to a user computer device, and the 3D parts system is configured to receive input from the user computer device and to output a 3D part model based on the received input.

15. The 3D parts system of claim 14, wherein the output 3D part model is communicated to a 3D parts fabrication device for fabrication.

16. The 3D parts system of claim 14, wherein the 3D parts system is configured to receive as input from a user computer device at least one of: a user's preferences, requirements, constraints and context for a 3D part, and to output a 3D part model that is optimized based on the received input.

17. The 3D parts system of claim 16, wherein the output model is selected from existing models in the 3D parts database.

18. The 3D parts system of claim 16, wherein the output model is generated by the system from the 3D parts database.

19. The 3D parts system of claim 14, wherein the 3D parts database is communicatively coupled to at least one of:
a digital rights management system for managing at least one digital right associated with the at least one model;
a copy protection system encrypting the at least one model with at least one encryption; and
an electronic commerce system in communication with at least one of the digital rights management system and the copy protection system, wherein the electronic commerce system controls at least one of purchasing, manufacturing, and delivering of a 3D part created from the at least one model.

20. The 3D parts system of claim 14, wherein the 3D parts database is communicatively coupled to a 3D parts production system comprising a 3D fabrication device for creating at least one 3D structure from the output model.

21. The 3D parts system of claim 20, wherein the 3D fabrication device is positioned within a fabrication facility, and wherein the 3D parts production system comprises a 3D structure transportation system comprising at least one of:
at least one internal transportation device positioned to move the 3D structure between a first fabrication site and a second fabrication site, wherein the first and second fabrication sites are located within the fabrication facility; and
at least one external transportation device positioned to transport the 3D structure between the fabrication facility and a location external to the fabrication facility.
